(19) United States
(12) Patent Application Publication
(10) Pub. No.: US 2012/0218762 A1
(43) Pub. Date: Aug. 30, 2012

(54) LED Molded Tree Branches with Blossoms

(76) Inventors: Isaac Weiser, Chatsworth, CA (US); Margaret Weiser, Chatsworth, CA (US)

(21) Appl. No.: 13/468,398

(22) Filed: May 10, 2012

Related U.S. Application Data
(63) Continuation of application No. 12/605,798, filed on Oct. 26, 2009, now Pat. No. 8,201,972.

(51) Int. Cl. F21S 4/00

(52) U.S. Cl. 362/249.06

(57) ABSTRACT

A decorative tree having a trunk, a plurality of individual limbs, and controlling electronics. Each individual limb has a molded branch and a plurality of lamp stems. Each lamp stern has an anode lead and a cathode lead, each electrically connected to an LED. The controlling electronics are electrically connected to each cathode lead and anode lead, and they provide an operating signal to the LED.

### CROSS-REFERENCES TO RELATED APPLICATIONS

This patent application is a continuation and claims the benefit of U.S. patent application Ser. No. 12/605,798 filed Oct. 26, 2009 for LED Molded Tree Branches with Blossoms. That application is incorporated here by this reference.

### TECHNICAL FIELD

This invention relates to decorative trees and shrubbery having LED.

### BACKGROUND ART

While there are existing decorative trees in the art, none have the combination of structures of the present invention and none are produced according to the methods of the present invention.

For example, U.S. Pat. No. 7,108,391 to Chuang purports to disclose an artificial miniature landscape model that includes a plurality of multi-colored LEDS, metallic conductor branches, electrically insulated conductors, heat shrink bushings, or insulation tubular plugs, or internally or externally threaded tubular connectors, a low voltage rectifier, base connectors, molded artifacts, and pots. A plurality of variable colored LEDS are affixed to a molded transparent resin structure of an artificial flower, fruit, bird, leaf or butterfly to exhibit a three dimensionally colored lighting effect. Further, connectors are provided for connection of electrical conductors that supply power to illuminate the LEDS and to operate electrical devices that accompany the miniature landscape model.

In addition, U.S. Pat. No. 5,947,582 to Huang purports to disclose a flower-shaped ornamental lamp that includes a mount, an artificial flower, a flexible tubular stem connected between the mount and the artificial flower, a flexible supporting rod inserted through the flexible tubular stem and connected between the artificial flower and the mount, a bulb mounted on the artificial flower, and an electric wire inserted through the flexible tubular stem and connected to the bulb for providing power supply to the bulb.

Also, US 2008/0273348 to Klohn et al. purports to disclose an electrically illuminated artificial plant display that may include a plurality of individual plant sprays, each spray including optical fibers and branch members bearing light emitting diodes, the optical fibers and branch members terminating at a plug that includes a readily replaceable colored lens to filter light which is transmitted to the fiber optic members and electrical contacts for transmitting power to the diodes disposed on the branch members. The plug may be insertable into a base unit that includes a plurality of receptacles, each receptacle adapted to receive a single plug. The receptacles may each include both electrical contacts and a light emitting diode such that the lens in the plug is positioned between the base unit's light emitting diode and the ends of the fiber optic cables when the plug is in an installed position.

What the existing art does not disclose is a decorative tree as described and claimed here.

### DISCLOSURE OF INVENTION

The decorative tree can generally be described as having a trunk, a plurality of individual limbs connected to the trunk, and controlling electronics. Each of the individual limbs has a plurality of lamp stems and a molded branch. Each lamp stem has an anode lead, a cathode lead, and an LED. The LED has an anode and a cathode. The anode is electrically connected to the anode lead and the cathode is electrically connected to the cathode lead.

The controlling electronics are electrically connected to each cathode lead and each anode lead and provide an operating signal to each LED.

### BRIEF DESCRIPTION OF DRAWINGS

FIG. 1 is a depiction of an embodiment of a LED Molded Tree Branches with Blossoms.

FIG. 2 is a depiction of a double limb for the embodiment of a LED Molded Tree Branches with Blossoms shown in FIG. 1.

FIG. 3 is a depiction of an individual limb for the embodiment of a LED Molded Tree Branches with Blossoms shown in FIG. 1.

FIG. 4 is a depiction of a limb frame for the embodiment of a LED Molded Tree Branches with Blossoms shown in FIG. 1.

FIG. 5 is a depiction of a lamp stem for the embodiment of a LED Molded Tree Branches with Blossoms shown in FIG. 1.

FIG. 6 is another depiction of a lamp stem for the embodiment of a LED Molded Tree Branches with Blossoms shown in FIG. 1 but without the molded lamp holder.

FIG. 6A is a close-up of a portion of FIG. 6.

FIG. 7 is a close-up of a first trunk section in cut-away for the embodiment of a LED Molded Tree Branches with Blossoms shown in FIG. 1.

FIG. 8 is a close-up of the second trunk section in cut-away for the embodiment of a LED Molded Tree Branches with Blossoms shown in FIG. 1.

FIG. 9 is a close-up of the third trunk section in cut-away for the embodiment of a LED Molded Tree Branches with Blossoms shown in FIG. 1.

FIG. 10 is a close-up of the fourth trunk section in cut-away for the embodiment of a LED Molded Tree Branches with Blossoms shown in FIG. 1.

FIGS. 11A, 11B, and 11C are detail views of a version of an ornamental blossom, shown in isolation.

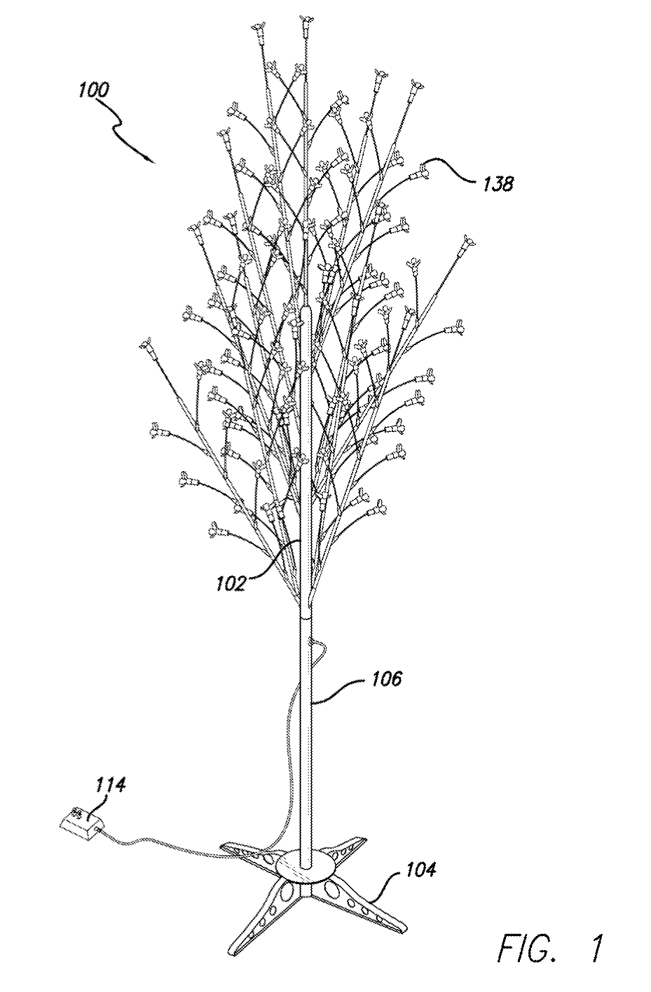

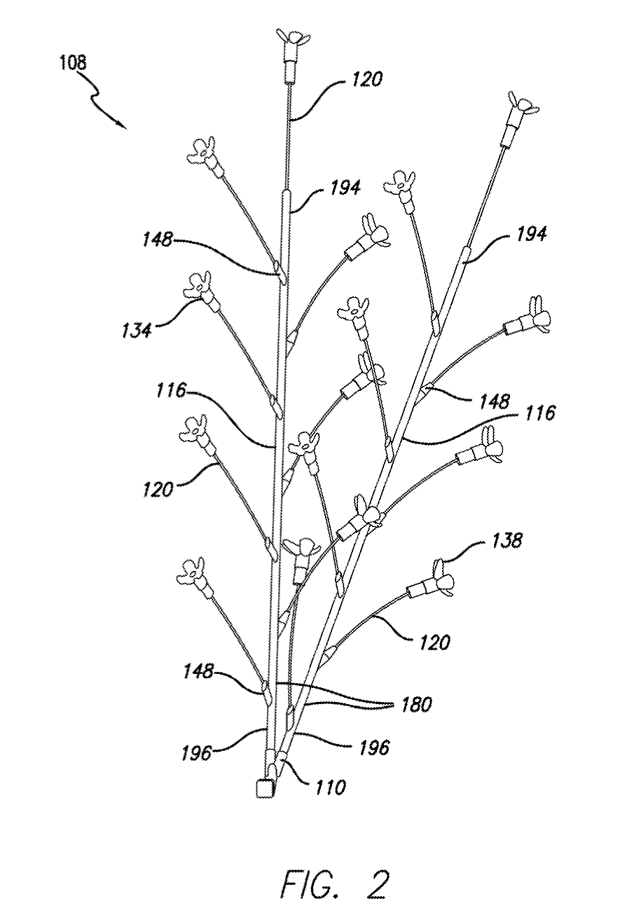

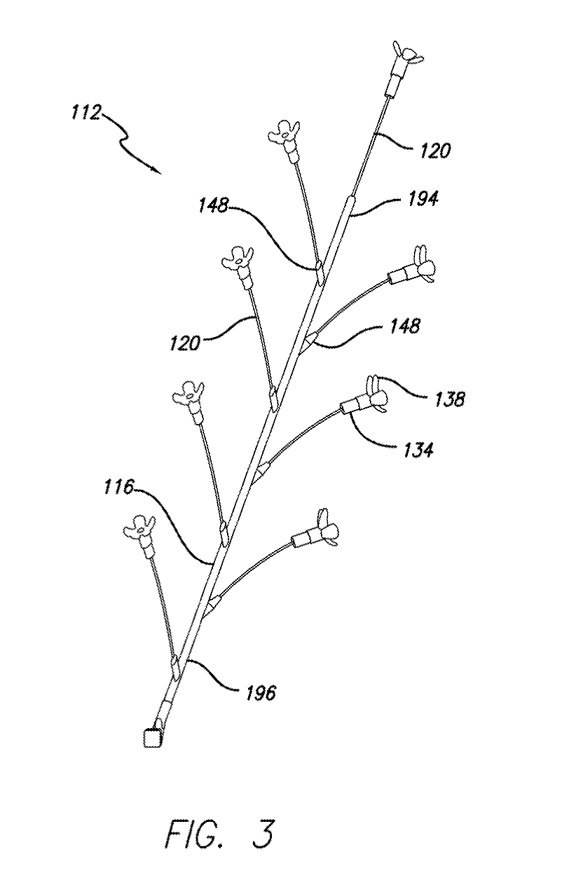

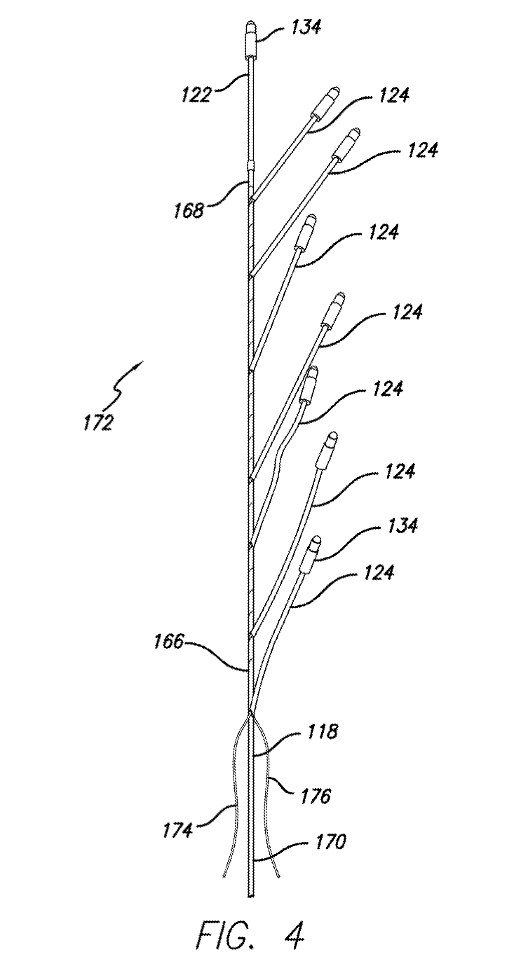

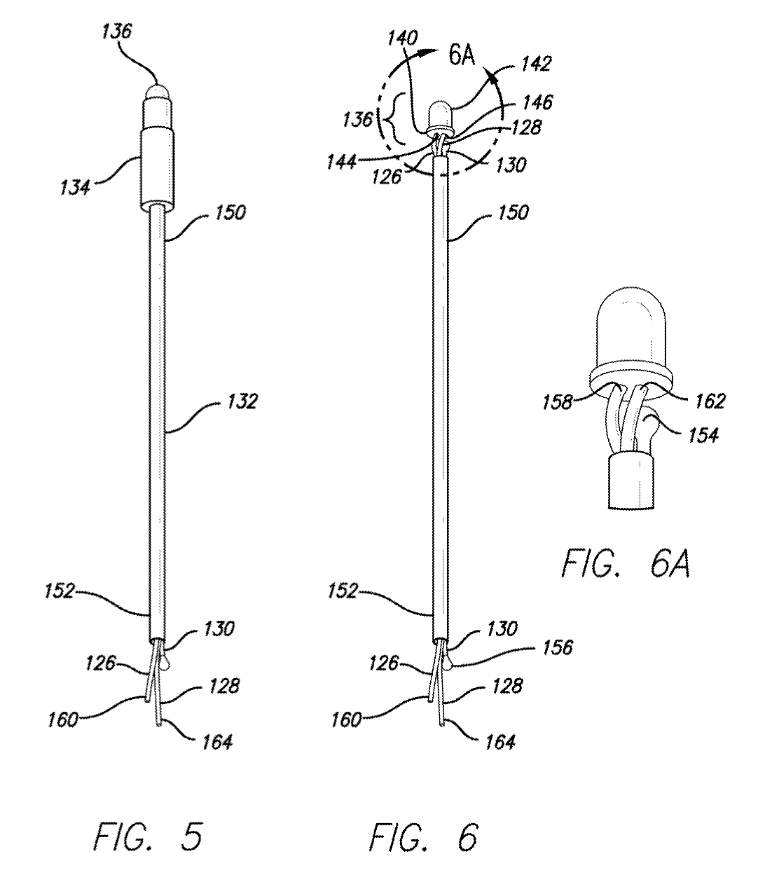

### BEST MODE FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may he accomplished by different embodiments that are also intended to be encompassed within the spirit and scope of the invention.

By reference to the figures, the decorative tree 100 preferably has a trunk 102, a support base 104 to support the decorative tree 100 on a surface such as a floor, a table, or the ground, an extension pole 106 to connect the trunk 102 to the support base 104 and to extend the trunk 102 away from the support base 104 at a desired distance, a plurality of double limbs 108 connected to the trunk 102 by a branch joint 110, a plurality of individual limbs 112 connected to the trunk 102, and controlling electronics 114.

Each of the double limbs 108 includes two individual limbs 112 joined at the branch joint 110. The two individual limbs 112 are preferably oblique to each other, and more preferably are at an angle of about ten to sixty degrees.

Preferably, there are six double limbs 108. Likewise, there are three individual limbs 112 connected directly to the trunk 102.

Each of the individual limbs 112 has a molded branch 116 formed around a structural rod 118 and a plurality of lamp stems 120. The structural rod 118 provides rigidity to the molded branch 116.

The plurality of lamp stems 120 includes a tip lamp stem 122 and a plurality of lateral lamp stems 124. In the depicted embodiment, there are eight lamp sterns 120 for each individual limb 112 and seven of those are lateral lamp stems 124.

Each lamp stem 120 also has an anode lead 126, a cathode lead 128, and a stiffening rod 130, all wrapped in a smooth sheath 132. The stiffening rod 130 preferably has flattened ends. Even with the stiffening rod 130, the lamp stem 120 remains bendable. This feature permits each lamp stem 120 to be positioned within the decorative tree 100.

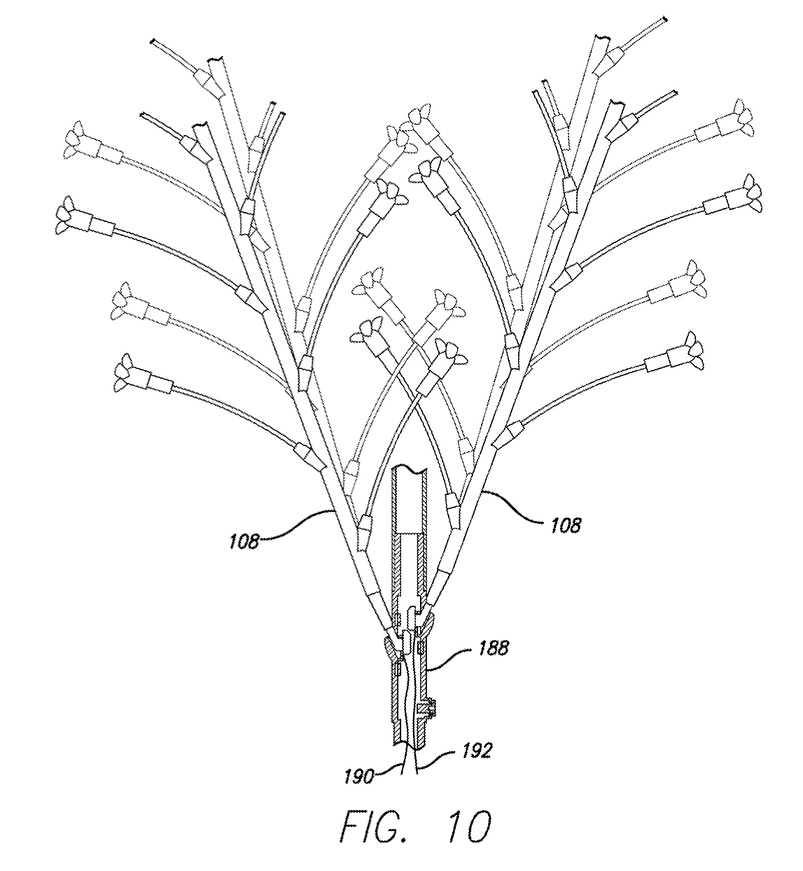

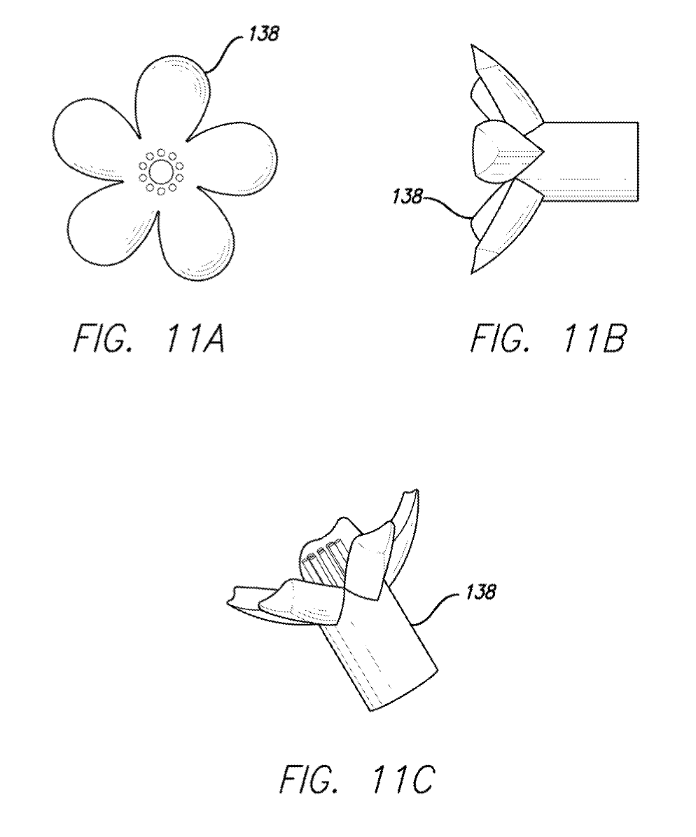

Each lamp stem 120 terminates in a molded lamp holder 134. The molded lamp holder 134 supports an LED 136 and preferably a limb ornament 138. The limb ornament 138 could be an ornamental blossom or an ornamental leaf. See FIG. 11A, FIG. 11B, and FIG. 11C.

The LED 136 has a lamp portion 140 with a light permeable surface 142. The LED 136 further has an anode 144 and a cathode 146. The anode 144 is electrically connected to the anode lead 126 and the cathode 146 is electrically connected to the cathode lead 128. The LED 136 preferably emits colored light. Examples of such colors are white, blue, green, red, pink, yellow, cyan, and magenta. Each lateral lamp stem 124 connects to the molded branch 116 at a molded branch fork 148 and the tip lamp stein 122 connects to an end of the stiffening rod 130.

The controlling electronics 114 are electrically connected to each cathode lead 128 and each anode lead 126 and provide an operating signal to the LED 136. The lighted decorative tree 100 can thus light up a garden, yard, porch, patio, and even the corner of a room.

Also, in a version of the invention, a method for producing a decorative tree 100 has the steps of forming a plurality of lamp stems 120, forming a plurality of individual limbs 112, forming a plurality of double limbs 108, forming a trunk 102, mounting the trunk 102, and electronically controlling each LED 136. Each of these steps is further discussed below.

The depicted embodiment shows one hundred and twenty lamp stems 120. In a version of the invention, the steps for forming each lamp stem 120 are:

(i) Cutting a lamp stem 120 to a desired length of about 145 mm. The lamp stem 120 has a first insulated wire 126, a second insulated wire 128, and a stiffening rod 130 wrapped together in a smooth sheath 132. The lamp stem 120 also has a first end 150, and a second end 152. Likewise, the stiffening rod 130 has a corresponding first end 154 and a second end 156, the first insulated wire 126 has a corresponding first end 158 and a second end 160, and the second insulated wire 128 has a corresponding first end 162 and a second end 164.

(ii) Peeling the smooth sheath 132 from about 20 mm of the first end 150 of the lamp stem 120, and peeling the smooth sheath 132 from about 20 mm of the second end 152 of the lamp stem 120. This peeling exposes the first ends 154, 158, 162 and the second ends 156, 160, 164 of the stiffening rod 130, the first insulated wire 126, and the second insulated wire 128.

(iii) Flattening the stiffening rod 130 at its first end 154 and second end 156.

(iv) Stripping the insulation from about 3 mm from the first end 158 and the second end 160 of the first insulated wire 126, and stripping the insulation from about 3 mm from the first end 162 and the second end 164 of the second insulated wire 128.

(v) Tinning the first end 158 and the second end 160 of the first insulated wire 126, and tinning the first end 162 and the second end 164 of the second insulated wire 128.

(vi) Attaching the first end 158 of the first insulated wire 126 to an anode 144 of an LED 136. The LED 136 has a lamp portion 140 with a light permeable surface 142.

(vii) Attaching the first end 162 of the second insulated wire 128 to a cathode 146 of the LED 136.

(viii) Testing the LED 136 to verify the LED 136 will emit light with an applied voltage.

(ix) Covering the flattened first end 154 of the stiffening rod 130 with masking tape 166 to avoid chafing of the first insulated wire 126 and the second insulated wire 128.

(x) Molding a molded lamp holder 134 around the first end 150 of the lamp stem 120. The molded lamp holder 134 supports the LED 136 at the first end 150 of the lamp stem 120.

(xi) Retesting the LED 136 to again verify the LED 136 will emit light with an applied voltage.

In a version of the invention, the steps for forming each individual limb 112 are:

(i) Selecting a tip lamp stem 122 and a plurality of lateral lamp stems 124 from the plurality of lamp stems 120 formed by the steps indicated previously. In the depicted embodiment, there are seven lateral lamp stems 124 and one tip lamp stem 122 for each individual limb 112.

(ii) Connecting the tip lamp stem 122 at a first end 168 of a structural rod 118.

(iii) Connecting the lateral lamp stems 124 to the structural rod 118 between the first end 168 and a second end 170 of the structural rod 118 and each at an angle to the structural rod 118, thereby forming a limb frame 172.

(iv) Connecting each of the first insulated wires 126 from each of the lamp sterns 120 in the limb frame 172 to form a first branch wire 174. The first branch wire 174 has a portion that extends beyond the second end 170 of the structural rod 118.

(v) Connecting each of the second insulated wires 128 from each of the lamp stems 120 in the limb frame 172 to form a second branch wire 176. The second branch wire 176 has a portion that extends beyond the second end 170 of the structural rod 118.

(vi) Retesting the LED 136 to again verify each LED 136 will emit light with an applied voltage.

(vii) Applying heat shrink tubing 178 to the connection between the structural rod 118 and the lamp stem 120 connected at the first end 168 of the structural rod 118.

(viii) Wrapping the structural rod 118, the first branch wire 174, and the second branch wire 176 together with masking tape 166.

(ix) Molding a molded branch 116 over the structural rod 118. The molded branch 116 has a first end 194 and a second end 196. The molded branch 116 includes a plurality of molded branch forks 148, where one molded branch fork 148 corresponds to a location where each lateral lamp stem 124 connects to the structural rod 118. The second end 170 of the structural rod 118 extends beyond the second end 196 of the molded branch 116.

(x) Retesting the LED 136 to again verify each LED 136 will emit light with an applied voltage.

The depicted embodiment shows six double limbs 108. In a version of the invention, the steps for forming each double limb 108 are:

(i) For two of the plurality of individual limbs 112 formed by the steps noted above, bending the second end 170 of the structural rod 118 to an angle of about 115 degrees. These two individual limbs 112 form a limb pair 180.

(ii) Aligning the bent ends and connecting the limb pair 180 at the bent second ends 170 through a molded branch 116 joint 110. The limb pair 180 preferably forms an angle of about ten to sixty degrees. The second ends 170 of the structural rods 118 of the limb pair 180 extend beyond the branch joint 110, the two first branch wires 174 extend beyond the branch joint 110, and the two second branch wires 176 extend beyond the branch joint 110.

(iii) Attaching a limb ornament 138 to each molded lamp holder 134. The limb ornament 138 could be an artificial blossom or an artificial leaf.

In a version of the invention, the steps for forming a trunk 102 are:

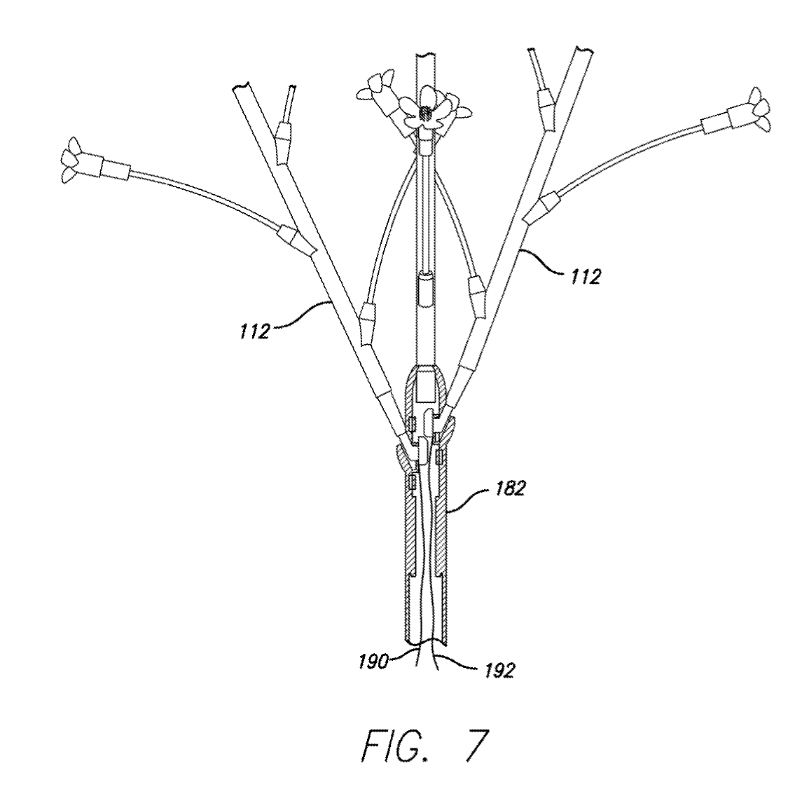

(i) Connecting a plurality of individual limbs 112 to a first trunk section 182. The depicted embodiment shows three individual limbs 112 connected to the first trunk section 182. Refer to FIG. 7.

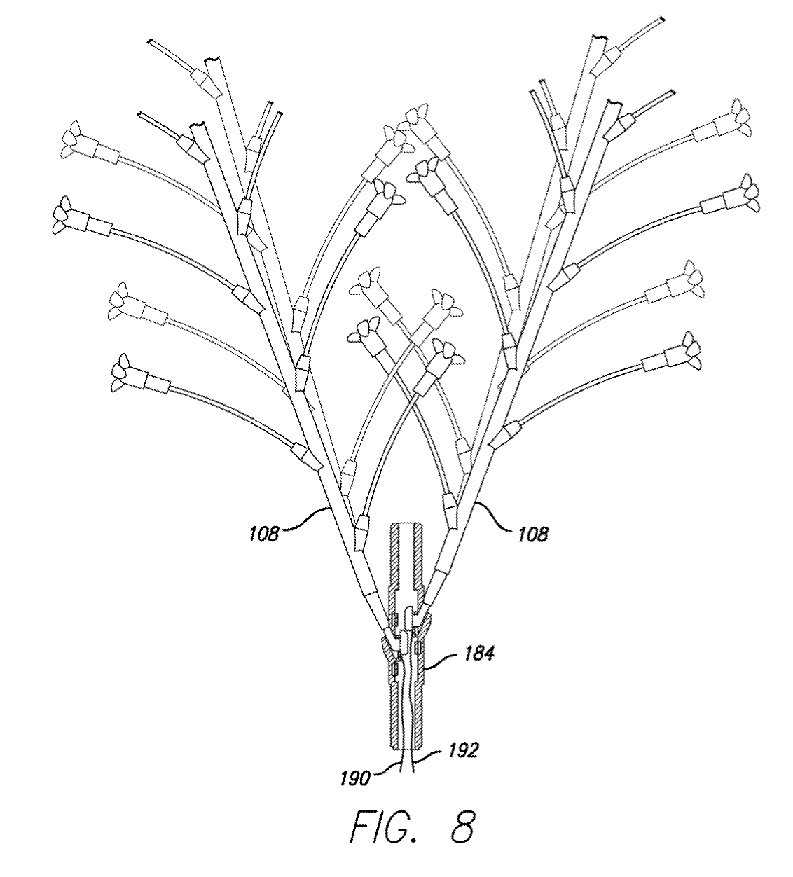

(ii) Connecting a plurality of double limbs 108 to a second trunk section 184. The depicted embodiment shows two double limbs 108 connected to the second trunk section 184. Refer to FIG. 8.

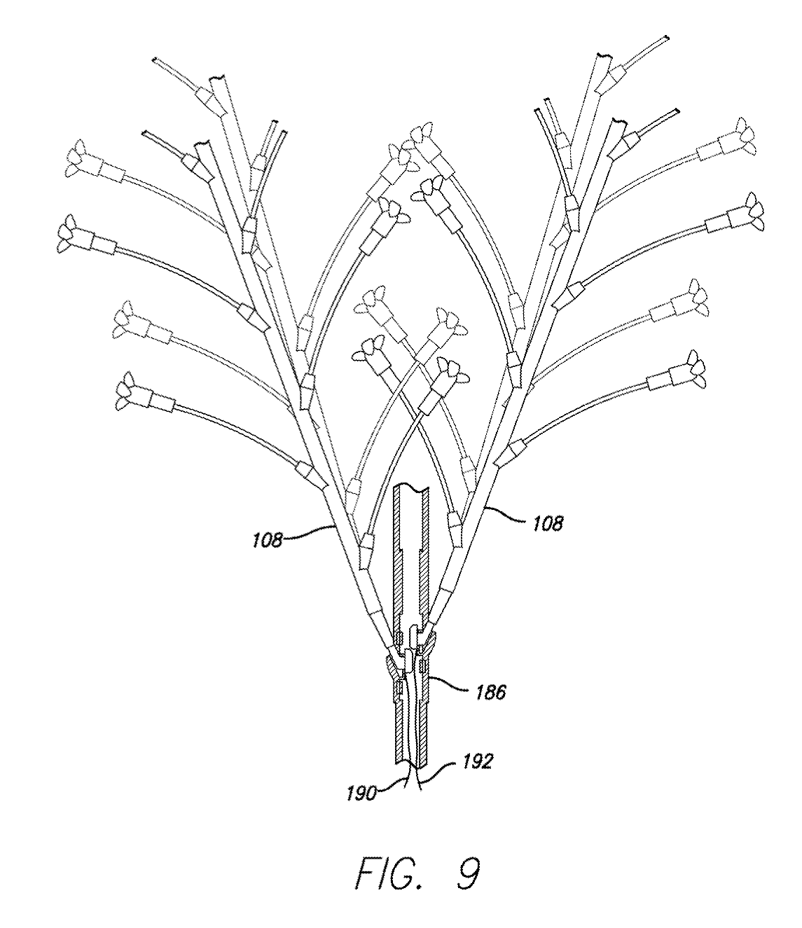

(iii) Connecting a plurality of double limbs 108 to a third trunk section 186. The depicted embodiment shows two double limbs 108 connected to the third trunk section 186. Refer to FIG. 9.

(iv) Connecting a plurality of double limbs 108 to a fourth trunk section 188. The depicted embodiment shows two double limbs 108 connected to the fourth trunk section 188. Refer to FIG. 10.

(v) Connecting the first trunk section 182 to the second trunk section 184, the second trunk section 184 to the third trunk section 186, and the third trunk section 186 to the fourth trunk section 188.

(vi) Electrically connecting each of the first branch wires 174 to each of the other first branch wires 174 to form a first trunk wire 190, and electrically connecting each of the second branch wires 176 to each of the other second branch wires 176 to form a second trunk wire 192.

(vii) Retesting the LED 136 to again verify each LED 136 will emit light with an applied voltage.

The steps for mounting the trunk 102 preferably are:

(i) Connecting the trunk 102 to an extension pole 106.

(ii) Connecting the extension pole 106 to a support base 104.

(iii) Retesting the LED 136 to again verify each LED 136 will emit light with an applied voltage.

Each LED 136 is electronically controlled by connecting controlling electronics 114 to the first and the second trunk wires 192. The controlling electronics 114 preferably cause the LED 136 to sequentially emit more than one color in a repeated sequence. Examples of such colors are white, blue, green, red, pink, yellow, cyan, and magenta.

While the present invention has been described with regards to particular embodiments, it is recognized that additional variations of the present invention may be devised without departing from the inventive concept.

### INDUSTRIAL APPLICABILITY

This invention may be industrially applied to the development, manufacture, and use of decorative trees and shrubbery having LED.

What is claimed is:

1. A decorative tree comprising:
(a) a trunk;
(b) a plurality of individual limbs connected to the trunk, where each individual limb comprises:
(i) a molded branch formed around a structural rod, the structural rod providing rigidity to the molded branch, and
(ii) a plurality of lamp stems including a tip lamp stem and a plurality of lateral lamp stems, each lamp stem having an anode lead, a cathode lead, and a stiffening rod wrapped in a sheath, where each lamp stem terminates in a molded lamp holder, the molded lamp holder supporting an LED, the LED having an anode and a cathode, the anode being electrically connected to the anode lead and the cathode being electrically connected to the cathode lead, and where each lateral lamp stem connects to the molded branch at a molded branch fork and the tip lamp stem connects to an end of the stiffening rod; and
(c) controlling electronics, the controlling electronics being electrically connected to each cathode lead and each anode lead and providing an operating signal to the LED.

2. A decorative tree comprising:
(a) a trunk;
(b) a plurality of individual limbs connected to the trunk, where each individual limb comprises a molded branch and a plurality of lamp stems, each lamp stem having an anode lead, a cathode lead, and an LED, the LED having an anode and a cathode, the anode being electrically connected to the anode lead and the cathode being electrically connected to the cathode lead; and
(c) controlling electronics, the controlling electronics being electrically connected to each cathode lead and each anode lead and providing an operating signal to the LED.

3. The decorative tree of claim 2, where at least two of the individual limbs are joined at a branch joint to form double limb, the two individual limbs being oblique to each other, and the double limb is connected to the trunk.

4. The decorative tree of claim 2, where the molded branch is formed around a structural rod, the structural rod provides rigidity to the molded branch.

5. The decorative tree of claim 2, where the plurality of lamp stems includes a tip lamp stem and a plurality of lateral lamp stems.

6. The decorative tree of claim 2, where each lamp stem has a stiffening rod.

7. The decorative tree of claim 6, where the stiffening rod has flattened ends.

8. The decorative tree of claim 2, where each lamp stem terminates in a molded lamp holder, and the molded lamp holder supports the LED.

9. The decorative tree of claim 8, where the molded lamp holder includes an ornamental blossom.

10. The decorative tree of claim 2, where the plurality of lamp stems includes a tip lamp stem and a plurality of lateral lamp stems, and each lamp stem has a stiffening rod, where each lateral lamp stem connects to the molded branch at a molded branch fork and the tip lamp stem connects to an end of the stiffening rod.
